(19) United States
(12) Patent Application Publication
(10) Pub. No.: US 2009/0254857 A1
(43) Pub. Date: Oct. 8, 2009

(54) WIRELESS COMMUNICATION DEVICE PRE-PURCHASE PERSONALIZATION

(76) Inventors: Christopher Romine, San Diego, CA (US); Dennis M. Feenaghty, Solana Beach, CA (US); John M. Burke, La Jolla, CA (US); Joseph P. Burke, Chicago, IL (US); Russell Mchugh, San Diego, CA (US)

Correspondence Address: QUALCOMM INCORPORATED, 5775 MOREHOUSE DR., SAN DIEGO, CA, 92121, US

(21) Appl. No.: 11/561,345

(22) Filed: Nov. 17, 2006

Related U.S. Application Data
(60) Provisional application No. 60/819,617, filed on Jul. 11, 2006.

(51) Int. Cl. G06F 15/16; G06F 3/048; G06Q 30/00

(52) U.S. Cl. 715/810; 709/219; 705/16

(57) ABSTRACT

A portable electronic device or wireless communication device (WCD) has at least one provision for optional equipment or user services. Options are provided for a user in a menu selection for selection by the consumer of the options. The user selects the options for the particular WCD and the options are installed on delivery or prior to delivery, thereby providing the user with an initial selection of the options.

### CLAIM OF PRIORITY UNDER 35 U.S.C §119

The present Application for Patent claims priority to Provisional Application No. 60/819,617, entitled MOBILE PHONE PRE-LOADED MEDIA CONTENT filed Jul. 11, 2006, and assigned to the assignee hereof and hereby expressly incorporated by reference herein.

### FIELD OF THE INVENTION

This invention relates to portable electronic devices such as wireless communication devices. More particularly, the invention relates to providing media content for such portable electronic devices, including an initial download of media content.

### BACKGROUND OF THE INVENTION

Wireless communication devices (WCDs) are becoming increasingly commonplace. For example, millions (if not billions) of individuals own and/or utilize one or more WCDs such as, but not limited to, a mobile phone, personal data assistant (PDA), a wireless gaming device and a computer with wireless capabilities. To support the growing numbers of WCDs, there are also many numbers of service provider. A user subscribes with one of these service providers to receive service.

Service providers have traditionally included bulky printed paper user manuals with a new WCD to show how to use the WCD and its features. Printed inserts are often provided with a new WCD to show how to use and purchase other advanced features. Salesperson demonstrations and printed advertisements at the point of sale are also used to show the advanced WCD and network features. Third party applications and accessory products are advertised separately using print and broadcast media. Service providers use free trials and broadcast messages/media over the network to the WCD to show a WCD or network feature. Users can also customize their WCDs after the point of sale by downloading content at their own expense.

As used herein, “media”, “software” and “features” which are loaded to a portable electronic device or WCD include hardware and software that supplements the capabilities of the WCD. In the case of music or video media, the media is primarily the recording; however, the downloadable content can be in the form of software or other data. Additionally, it is possible to provide additional hardware features for an electronic device, as is common in the case of packaged computers.

One difficulty in providing such initial content is the reluctance of users to either engage services in general or engage a service associated with downloading an initial set of media. For this reason, pre-loaded software is provided along generic interests which are not necessarily of interest to the user.

Wireless communication devices (WCDs) are being designed with larger storage space; however the additional storage space is useless until a user loads it with content after purchase. There is a tendency for users to either avoid or postpone downloading media for a number of reasons, including the need to learn the operating procedures for a new device, the time required to select the downloads, initial setup procedures, and user anticipation that an initial download will invoke fee-based subscriptions.

Similarly, portable electronic devices with large amounts of storage are often designed for optimum use of the data (e.g., presentation of the media), and the download functions for obtaining the media are limited. That means that the initial loading of large amounts of data can be time consuming. In many cases, it is desired to provide the user with an initial set of data that is either provided to the user free of charge or provided to the user for a fee. In either ease, the “cost” of downloading can include a considerable amount of time required for downloading what may be a substantial volume of initial data.

Existing pre-purchased media arrangements provide either fixed configurations of media, such as software or a predetermined set of ringtones, or implement user selection by a pre-purchase or “coupon” system requiring the user to download a selection of media. In part, this is because a particular category of media that the user may wish to purchase does not necessarily indicate which selections the user may desire from that particular category of media.

For example, an MP3 media player may include a “special edition” version focusing on a particular artist. The user may be entitled to download a predetermined number of recordings by the artist as a part of the purchase of the “special edition” but it is generally desired to allow the user to make the selection. Existing systems use a “coupon” to go online and download content after the hardware is already purchased and delivered. Therefore the “special edition” still is encumbered by the issues of time and effort of download.

Hardware options present different issues. While it is commonplace to include accessories as part of a purchase, these have been limited to either external accessories, or accessories which are amenable to consumer installation, such as antennas or memory cards. Other hardware options may be provided, but the nature of the device is such that these options would be hardwired to the device. Examples of hardwired options would be internal memory, ability to operate on different frequency bands or system protocols, display options, and additional hardware functions such as internal Bluetooth support. Therefore, even if the design of the WCD is such that different features can be optionally incorporated, consumer selection of these options has essentially required the equivalent of stocking different models of the same device. With a variety of different hardware options, the logistics of stocking different combinations of options makes a full selection impractical.

### SUMMARY

A method is implemented to provide content for portable electronic device or wireless communication device (WCD) that has at least one data store for user services. A selection of content is provided for pre-loading to the data store. A portion of the content is loaded in accordance with the selection and the loaded portion of the content is provided for access by the user.

According to one aspect, in a WCD for use in a subscriber based wireless communication system, a selection of content is provided for pre-loading to a data store for user services. A portion of the content is loaded to tire data store and provided for access by the user through the data store. In one particular aspect, a menu for selection of content is provided to a consumer for acceptance by the consumer. The content is then loaded as pre-loaded content in order to provide the consumer with an initial selection.

In another aspect a portable electronic device or WCD capable of providing user communication services includes a communication circuit, storage for storing content downloaded by a user through the communication circuit and a data port. The data port is configurable to accept data prior to placing the portable electronic device or WCD into service with the user. The data is thereby accepted prior to placing the portable electronic device into service provides the user with an initial content.

In another aspect, a portable electronic device or WCD includes means for providing a selection of content for pre-loading to the data store, means for loading a portion of the content to the data store, and means for providing the loaded portion of the content for access by the user.

In yet another aspect, means are provided for preloading content to portable electronic devices and/or WCDs in order to provide an initial content of user accessible data. The means include means for providing a selection of content for pre-loading to a data store in the portable electronic device or WCD, and means for loading a portion of the content to the portable electronic device or WCD. This allows the portable electronic device or WCD to store in a data store for the portable electronic device or WCD to provide the content for access by the user.

In another aspect, a processor for use in a portable electronic device or WCD includes a circuit for accepting content downloaded by a user through a communication circuit and storing the content in the portable electronic device or wireless communication device, and a circuit for accepting data through a data port prior to placing the portable electronic device or WCD into service with the user. The circuit for accepting data provides an initial content accessible by a user through the storage. The data accepted prior to placing the portable electronic device or WCD into service provides an initial selectable configuration of the portable electronic device or WCD of a type otherwise obtained through the communication channel.

In another aspect, a storage medium contains instructions for use in providing preloaded content in a portable electronic device or WCD. The storage medium includes instructions for operating a communication circuit to provide a selection of content, instructions for storage for storing content through the communication circuit and instructions to control a data port to accept data prior to placing the portable electronic device or WCD into service with the user. The data accepted prior to placing the portable electronic device into service provides the user with an initial content.

In another aspect, user services for portable electronic devices or WCDs are provided at a point of sale. A selection of content is provided for pre-loading to a data store on a portable electronic device or WCD. The selected content is provided to the WCD for loading to the data store, thereby providing a purchaser with the selected content through the portable electronic device or WCD.

In yet another aspect, a method is used to provide a WCD with configurable hardware as provided to a user. The user is provided with a basic selection of a WCD, and a selection of options for the WCD. The selection of options is incorporated into the WCD and the WCD with the options is provided to the user.

### BRIEF DESCRIPTION OF THE DRAWINGS

FIG. 1 is a diagram illustrating an example of a wireless communication network.

FIG. 3 is a diagram showing the procedure for providing pre-loaded user options or services.

FIG. 4 is a diagram showing a processor capable of downloading selected content.

FIG. 5 is a block diagram showing the functional operation of providing user options.

### DETAILED DESCRIPTION OF THE INVENTION

### Operational Environment

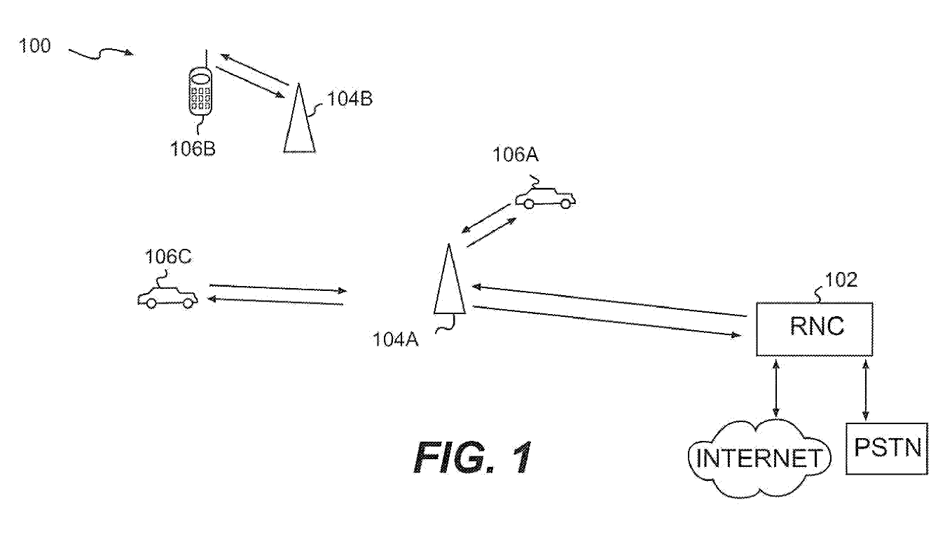

FIG. 1 is a diagram illustrating an example of a wireless communication network showing a basic wireless environment 100 using one or more radio network controllers(RNCs) 102, or local control stations such as base station controllers (BSC) or Node Bs, and a plurality of base stations (BS) or access points (APs) 104A, 104B, sometimes referred to as base station transceiver systems. Base stations 104A-104B communicate with remote stations or wireless communication devices (WCDs) 106A, 106B, 106C and are able to provide media or other content for download by the WCDs 106A-106C as downloadable data, which may be obtained, for example, from the network, from internet connections, from a public switched telephone network or from other sources. WCDs 106A-106C each have or comprise apparatus for wireless communications such as, but not limited to, a cellular telephone, a wireless handset, a data transceiver, or a paging or position determination receiver. Furthermore, such WCDs can be hand-held, portable as in vehicle mounted, (including cars, trucks, boats, trains, and planes) or fixed, as desired. Wireless communication devices are also sometimes referred, to as user terminals, mobile stations, mobile units, subscriber units, wireless transmit/receive units, mobile radios or radiotelephones, wireless units, or simply as “users”, “phones”, “terminals”, or “mobiles” in some communication systems, depending on preference. Base stations 104A-104B may form part of a wireless communication system, such as a terrestrial based communication systems and networks that include a plurality of cell sites. Signals can be formatted in accordance with any appropriate standard, such as IMT-2000/UMT standards, using WCDMA, cdma2000 or TD-SCDMA type signals, or can be associated with other systems, WCDs 106A-106C and base stations 104A-104C use signals that are encoded, spread, and channelized according to the transmission standards of the network. These parameters are by way of example, and the present invention may be employed in systems that employ other wireless communication techniques.

Targeted video and images can be pre-loaded into WCD storage devices providing improved revenue opportunities for service providers, WCD manufacturers, and other companies in the supply chain. The pre-loaded information can help WCD users learn how to use WCD features and services and can be used to advertise related products/services. Pre-loaded media content on a WCD is less costly than downloading the media over-the-air. It is a more effective way to target users, as users will be reluctant to download such media OTA at their expense. Higher speed wired and wireless connections to the WCD also permit a manufacturer to cheaply load customized content onto a mobile device to build WCDs to an individual user's preference.

The problem of providing initial data is solved by inexpensively directly targeting the WCD user with media that shows how to access and use the WCD features and services available. Media for related products and services can be embedded directly on the WCD. For example, a manufacturer of a WCD or a service provider could embed media showing other products or services it offers. Examples of such products may include items for which the WCD is adapted to work with, such as Bluetooth headset, flat screen TV, home appliances controlled by the WCD. A service provider could embed media demonstrating other related services (e.g. rate plans, music download services, online gaming, movie trailers, etc.) and unrelated services (DSL, home long distance, etc.) offered by the service provider. Downloadable applications (e.g. BREW applications) could be advertised by the service provider or the application developer. Pre-loaded instructional videos can be provided on how to use WCD features and services that can influence revenue resulting from data-related operations, such as initiating a streaming media mode, transferring pictures, using GPS navigation features, etc. Pre-loaded videos can also help users to utilize other WCD features such as configuring a Bluetooth headset or setting password protection. There is an opportunity to effectively demonstrate (at a low cost) third party related items such as commercials for downloading games, applications, MP3 download sites, and related products such as printers. The videos could show how easy the services are to use and could contain links to click through and purchase items. A printer advertisement could show how easily the printer integrates with the WCD via a print communication application, and could provide a link to buy the printer and printer accessories such as photo paper and ink. The WCD user can also customize exactly what content the user wants on the WCD before purchase, and the device can be pre-loaded at low cost to meet the user's requirements.

Three trends have created an opportunity for the wireless industry to capitalize on WCDs have larger data storage devices, WCDs contain more complex features, and WCDs have high speed wired and wireless interfaces making it possible for manufacturers to pre-load targeted media to WCDs at a low cost per WCD. Pre-loaded video and images can help enable the use of WCD features that enable additional revenue sources. The use of many WCD applications increase revenue from data-related applications, but many users are not taking advantage of the features that generate additional revenue for the service provider and others in the supply chain. Help instructional videos pre-loaded in the WCD's data storage devices by the WCD manufacturer can help improve the hit rate for new and/or complex WCD features. Videos offering users related products and services can he stored on the WCD, as opposed to relying on users to download such commercials over-the-air (OTA) at their expense. Users could also order WCDs customized for them (“built to order”) with pre-loaded media content.

### Point of Purchase or Selection Prior to Purchasing Portable Electronic Device or WCD

The system gives the user ability to personalize their WCD or other portable electronic device with media and software content at the time of purchase. The user can pre-load the portable electronic device with media content (MP3's, movies, games, ringtones, applications, operating system, etc). The manufacturer, carrier or distributor will use a build to order system (website, sales kiosk, order form) to allow user to select from library of options.

The consumers can also select hardware options at point of sale or from a “build your own” website, as will be described infra,

The preloading of media content or selection of hardware options can be accomplished in accordance with the user's selected purchase channel. In the case of WCDs this includes in-store purchase at a service provider's retail outlet, independent, outlets such as electronics retailers, and internet purchase. Thus the purchaser can request a “build to order” device with preloaded media content or hardware options with a minimum of effort. This enables the service provider to offer new methods for WCD customer to customize content, applications and/or the user interface at time of purchase, either through on-line or telephone-ordering or at a physical point-of-sale.

One way that the content could get to the end user handset is by an SMS from the website where the user chose the desired theme. The SMS could have a BREW link or WAP link. When the BREW or WAP link is selected, the theme is downloaded from the website. The user interface, various media such as screens and ringtones and particular aspects of the user interface can be provided as an integrated theme. The integrated theme can be provided as bundled content in a manner that provides a default user interface closely suited to the user's expressed preferences. The user can then use the portable electronic device or WCD with the defaults or edit the device's setup as desired. The theme can take the form of a Trig, which is a custom user interface for BREW devices.

A WCD customer is able to select content based on various offerings. These can include providing a tiered amount of content, pricing plan based on data size and/or number of applications, bundled theme packages.

In the case of an internet purchase, customization can be achieved by the manufacturer of the portable electronic device or WCD. The service provider provides content to device manufacturer, and the service provider provides order info to device manufacturer. The manufacturer then customizes content by associating a device ID to specific order.

In the case of point of sale purchase, customization is handled by retailer. The customer uses on-site application hardware to select custom content. The same hardware then programs the portable electronic device or WCD with selected content

In a manufacturing; process for the portable electronic device or WCD, the manufacturer associates a device ID such as a WCD ID with a purchase order. This permits custom content to be based on unique customer order. Content tied to one of a number of bundled end products may be offered by the service provider.

In a content download process, batches of a particular portable electronic device or WCD can be provided based on particular product configurations to provide bundled content. Additionally, the system makes it possible to process the portable electronic device or WCD individually for unique customer orders.

The system provides an ability to “build to order” for portable electronic devices and WCDs. It allows simple and complete personalization and customization with user demanded content, applications and user interfaces. The selection by users provides a form of automatic market feedback for service provider.

### Hardware Options

The use of a “build to order” consumer input at the time of purchase also permits the consumers to select hardware options at point of sale or from a “build your own” website. To the extent that the basic model of WCD can accept different hardware modules, this provides the consumer with the opportunity to select and/or enable certain wireless features. Typical features may include Bluetooth, WUSB, WiFi, CDMA, GSM, WCDMA, etc. Other examples of hardwired options would be internal memory, ability to operate on different frequency bands or system protocols, display options, and additional hardware functions such as internal Bluetooth support. While some such options may require completely different hardware configurations, other options may be implemented with either a software modification or an addition of a particular hardware module to provide the desired feature. These features may include internal features and hardwired features because the selection can be made while the WCD is at a facility that is easily able to provide such options.

FIG. 2 is a diagram showing an example configurable WCD 200, which enables a purchaser to include optional features on a “build to order” basis. The “build to order” WCD includes a base unit 202, and the base unit 202 includes circuitry 204 for providing a predetermined basic set of a WCD functions. Additional hardware such as an added RF device 207 connected by a ribbon cable 208 or a modified signal processor 211 socketed to the motherboard of the circuitry 204 of the base unit may be added or changed out at a manufacturing facility, distribution facility or point of sale.

The base unit 202 may be operable or inoperative as constructed, but would include the basic hardware configuration (base unit 202) such that final assembly can be easily accomplished. The final assembly can be provided either at a manufacturing facility, distribution location or at a point of sale, depending on the complexity of the procedure for physically adding the options. By providing the base unit 202, the configuration of the WCD with options can be accomplished without involving complex manufacturing processes in the selection. By “complex”, it is meant to indicate that a manufacturing process of the complexity consistent with overall construction of a WCD. A less complex process used for configuring options would be a substantially less complex manufacturing process. The less complex process can be performed in a final configuration stage at the manufacturer's facility, at a distribution center or at a point of sale without complex manufacturing techniques because the base unit 202 has already been constructed. It may be that the additional components added as options require complex manufacture, but the addition of the options to the base unit 202 is easily accomplished at a final configuration stage. An example of a less complex process would be the connection of a circuit provided as an add-on circuit, which could be accomplished by field soldering, socketing, or by cable connection.

The ability to provide hardware options means that the consumer and vender is not constrained by the logistics of stocking WCDs with a large variety of combinations of options. The ability to provide pre-purchase selection of options also simplifies the process of informing the consumer if particular combinations of options are incompatible, for example due to physical space constraints.

The ability to provide “build to order” consumer input also permits “either/or” options, in which a consumer can choose between hardware features according to preference. If the internal design of the WCD is such that space is limited, the consumer may wish to select built-in features that consume space. For example a small WCD may be offered with a choice of internal Bluetooth support, AMPs capability, or an ability to roam on an incompatible network. If these capabilities conflict with one another because of the physical space constraints of the device, it would still be possible to offer the selection of a subset of capabilities to the consumer.

### Preloaded Services Provided in “Pay Placement Protocol”

In a “pay placement protocol”, a third party pays for the placement of media, in order to make it available to the user. The ability to selectively preload data or other features also provides an opportunity for advertisers to pay for content placement on a WCD or other portable electronic device in storage space as “pay placement protocol” media. This can also be perforated in a manner which allows the purchaser to elect to accept particular content.

Preloaded Content Provided by User from Personal Library

The ability to selectively pre-load data or other features also provides an opportunity for the user to store personal content on a WCD or other portable electronic device in storage space as personalized media. This can also be performed in a manner which allows the purchaser to push the particular content to the carrier or manufacturer before the WCD is built. This personal can in the form of pictures, videos, music files, address books, calendars, and the like. By way of example, the selects photos for various menus and these photos are automatically converted into background screens. Likewise, a service provider can download pre-existing user content over the air or via a dataport from an existing phone and then upload the content into new phone before delivery to the customer.

### Implementation

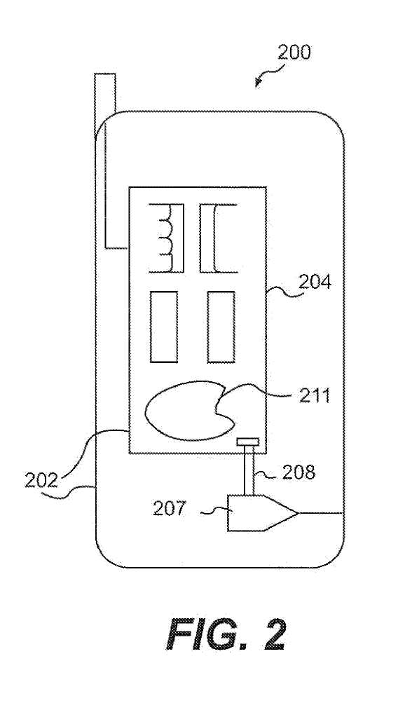

FIG. 3 is a diagram showing the procedure 300 for providing pre-loaded user services. A selection of content is provided (step 311) for pre-loading to the data, store. A portion of the content is loaded (step 313) to the data store in accordance with the selection. The loaded portion is provided (step 315) for access by the user.

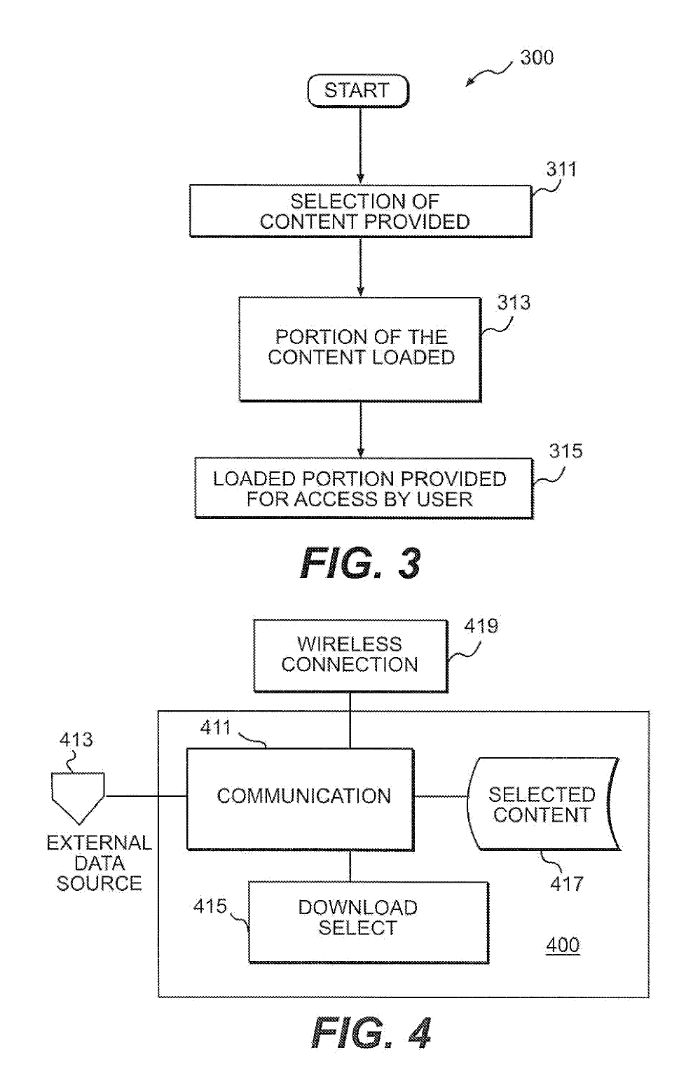

FIG. 4 is a diagram showing a processor 400 capable of downloading selected content. The processor includes a communication circuit 411, an external connection circuit 413, a download selection circuit 415 and a data store 417. The download selection circuit 415 is used to select content for storage in the data store 417 from a wireless network or other external connection. In an initial preload operation, the selection is made of the initial content, which is stored in the data store 417 in much the same manner, but without the need for the user to invoke services through the WCD. Later downloads are effected through the communication circuit 411 either through the external connection circuit 415 or through a wireless connection 419.

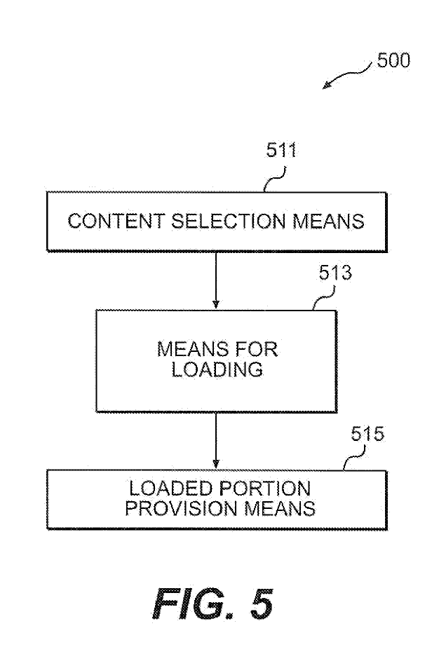

FIG. 5 is a block diagram 500 showing the functional operation of providing user options. Means for providing a selection 511 for pre-loading content to the data store are provided, and can be, for example, a computer menu selection or a series of selection keys in a kiosk. Means for loading 513 a portion of the content are provided, which can include a communication port, and a communication controller. Additionally, the means for loading 513 can include a computer device, used for providing the content for pre-loading. Means for providing the loaded portion 515 of the content for access by the user include the above-mentioned means for loading 513. From the user's perspective, the means for providing the loaded portion 515 include the storage of the WCD. From the service provider's perspective, the means for providing the loaded portion 515 to the user is the computer device used for providing the content.

In usage, the initial contents can be downloaded via hard-wired serial port (UART, USB, etc). Alternatively, content can be downloaded by wireless means by the portable electronic device's or WCD's embedded wireless technology (WUSB, CDMA, GSM, WCDMA, BT, etc.)

Since content can be provided at point of sale or during manufacture, it is possible to provide updated content or services without substantial investments in manufacturing changes for each update. This also provides for service differentiation for WCDs provided to different service providers.

1. In a portable electronic device or wireless communication device (WCD), wherein at least one data store provides storage for user services, a method for providing services for a user comprising:
providing a selection of content for pre-loading to the data store;
loading a portion of the content to the data store; and
providing the loaded portion of the content for access by the user.

2. The method of claim 1, wherein the portable electronic device or WCD provides user services through a subscriber based wireless communication system, in which multiple portable electronic devices or WCDs provide user communication services.

3. The method of claim 1, comprising:
providing the menu for selection, of content as an on-line menu;
loading the selected content to the data store at a distribution location; and
sending the WCD to the user with the loaded content.

4. The method of claim 1, comprising:
providing the menu for selection at a point of sale location; and
loading the selected content to the data store at the point of sale location, thereby providing the user with the WCD with the loaded content.

5. The method of claim 1 comprising providing the selection at a retail point of sale location.

6. The method of claim 1 comprising providing the selection as a part of a ordering procedure for purchase of the portable electronic device or WCD.

7. The method of claim 1 comprising providing, selected content as pay placement protocol media, selected in accordance with user preferences or other selection criteria as a part of a purchase of the portable electronic device or WCD.

8. In a wireless communication device (WCD) for use in a subscriber based wireless communication system, in which multiple WCDs provide user communication services, a method for providing services for a user comprising:
providing a menu for selection by a consumer of options;
accepting a selection of at least one option for a particular WCD selected by the consumer; and
installing the selected option into the WCD, thereby providing the user with an initial selection of the options.

9. The method of claim 8, comprising:
providing a selection of content for pre-loading to at least one data store provided on the WCD for storage of user services;
loading a portion of the content to the data store; and
providing the loaded portion of the content for access by the user.

10. The method of claim 9, comprising:
providing the menu for selection of content as an on-line menu;
loading the selected content to the data store at a distribution location; and
sending the WCD to the user with the loaded content.

11. The method of claim 8, wherein the portable electronic device or WCD provides user services through a subscriber based wire-less communication system, in which multiple portable electronic devices or WCDs provide user communication services.

12. The method of claim 8, comprising:
providing the menu for selection at a point of sale location;
installing the selected option at the point of sale location, thereby providing the user with the WCD with the option; and
providing the selection as apart of a ordering procedure for purchase of the portable electronic device or WCD.

13. A portable electronic device or wireless communication device (WCD) capable of providing user communication services, including communication of content, the portable electronic device or WCD comprising:
a communication circuit;
storage for storing content downloaded by a user through the communication circuit; and
a data port configurable to accept data prior to placing the portable electronic device or WCD into service with the user, whereby the data accepted prior to placing the portable electronic device into service provides the user with an initial content.

14. A portable electronic device or wireless communication device (WCD) capable of providing user communication services, including communication of content, wherein at least one data store provides storage for user services, the portable electronic device or WCD comprising:
means for providing a selection of content for pre-loading to the data store;
means for loading a portion of the content to the data store; and
means for providing the loaded portion of the content for access by the user.

15. The portable electronic device or WCD of claim 14, wherein the loaded portion of the content provides the user with an initial content accessible by a user through the storage as an initial selectable configuration of the portable electronic device or WCD of a type otherwise obtained through the communication channel.

16. A wireless communication device (WCD) with configurable hardware, comprising:
a base unit including circuitry for providing a predetermined basic set of a WCD functions; and
at least one circuit connection providing a selection of at least one option for the WCD, the options providing configurations of the WCD, in accordance with a user's selection of the option, prior to final delivery to the user, whereby the configurations provide the user with the WCD incorporating the user's selection of the options.

17. The WCD of claim 16, wherein the portable electronic device or WCD provides user services through a subscriber based wireless communication system, in which multiple portable electronic devices or WCDs provide user communication services.

18. The WCD of claim 16, further comprising:
a communication circuit;
storage for storing content downloaded by a user through the communication circuit; and
a data port configurable to accept data prior to placing the portable electronic device or WCD into service with the user, whereby die data accepted prior to placing the portable electronic device into service provides the user with an initial content.

19. Means for providing preloaded content to portable electronic devices and/or wireless communication devices (WCDs) in order to provide an initial content of user accessible data, the means for providing preloaded comprising:
means for providing a selection of content for pre-loading to a data store in the portable electronic device or WCD; and
means for loading a. portion of the content to the portable electronic device or WCD, for the portable electronic device or WCD to store in the data store to provide the eon tent for access by the user.

20. The means of claim 19, wherein the selection of content for pre-loading provides the user with an initial content accessible by a user through fee storage as an initial selectable configuration of the portable electronic device or WCD of a type otherwise obtained through the communication channel.

21. A processor for use in a portable electronic device or wireless communication device (WCD), the portable electronic device or WCD comprising:
a circuit for accepting content downloaded by a user through a communication circuit and storing the content in the portable electronic device or wireless communication device; and
a circuit for accepting data through a data port prior to placing the portable electronic device or WCD into service with the user and providing an initial content accessible by a user through the storage, whereby the data accepted prior to placing the portable electronic device or WCD into service provides an initial selectable configuration of the portable electronic device or WCD of a type otherwise obtained through the communication channel.

22. The processor of claim 21, comprising a circuit for accepting data prior to placing the portable electronic device into service to provide the user with an initial content accessible by a user through the storage as an initial selectable configuration of the portable electronic device or WCD of a type otherwise obtained through the communication channel.

23. A storage medium containing instructions for use in providing preloaded content in a portable electronic device or wireless communication device (WCD), the storage medium comprising:
instructions for operating a communication circuit to provide a selection of content;
instructions for storage for storing content through the communication circuit; and
instructions to control a data port to accept data prior to placing the portable electronic device or WCD into service with the user, whereby the data accepted prior to placing the portable electronic device into service provides the user with an initial content.

24. The portable electronic device or WCD of claim 23, comprising instructions for accepting data prior to placing the portable electronic device into service, thereby providing the user with an initial content accessible by a user through the storage as an initial selectable configuration of the portable electronic device or WCD of a type otherwise obtained through the communication channel.

25. A method for providing user options for portable electronic devices or wireless communication devices (WCDs) at a point of sale, the method comprising:
providing a selection of at least option on a portable electronic device or WCD; and
installing the selected option on the portable electronic device or WCD.

26. The method of claim 25, comprising:
providing, as an option, a selection of content for pre-loading to a data store on the portable electronic device or WCD; and
providing the selected content to the WCD for loading to the data store, thereby providing a purchaser with the selected content through the portable electronic device or WCD.

25. The method of claim 26, comprising:
providing the menu for selection of content as an on-line menu;
loading the selected content to the data store at a distribution location; and
sending the WCD to the user with the loaded content.

26. The method of claim 26, comprising:
providing the menu for selection at a point of sale location; and
loading the selected content to the data store at the point of sale location, thereby providing the user with the WCD with the loaded content.

27. The method of claim 26 comprising providing selected content as pay placement protocol media, selected in accordance with user preferences or other selection criteria as a part of a purchase of the portable electronic device or WCD.

28. The method of claim 25, comprising:
providing the menu for selection of the options as an on-line menu;
providing the selected options at a distribution location; and
sending the WCD to the user with the loaded options.

29. The method of claim 25 comprising providing the selection at a retail point of sale location.

30. The method of claim 25 comprising providing the selection as a part of a ordering procedure for purchase of the portable electronic device or WCD.

31. The method of claim 25, wherein the portable electronic device or WCD provides user services through a subscriber based wireless communication system, in which multiple portable electronic devices or WCDs provide user communication services.

32. A method of providing a wireless communication device (WCD) with configurable hardware as provided to a user, the method comprising:
providing a basic selection of a WCD;
providing a selection of options for the WCD;
incorporating tile selection of options; and
providing the WCD with the options to the user.

33. The method of claim 32, wherein the WCD provides user services through a subscriber based wireless communication system, in which multiple WCDs provide user communication services.

34. The method of claim 32, comprising:
providing the menu for selection of options as an on-line menu;
installing the selected options to the WCD at a distribution location; and
sending the WCD to the user with the installed options.

35. The method of claim 32, comprising:
providing the menu for selection of hardware options as an on-line menu;
installing the selected hardware options WCD; and
sending the WCD to the user with the installed options.

36. The method of claim 32, comprising:
providing the menu for selection at a point of sale location; and
installing the selected options to the WCD at the point of sale location, thereby providing the user with the WCD with the installed options.

37. The method of claim 32 comprising providing the selection at a retail point of sale location.

38. The method of claim 32 comprising providing the selection as a part of a ordering procedure for purchase of the portable electronic device or WCD.

39. In a portable electronic device or wireless communication device (WCD), wherein at least one data store provides storage for user services, a method for providing services Tor a user comprising:
allowing user to post pre-existing user owned content for pre-loading to the data store;
loading a portion of the content to the data store; and
providing the loaded portion of the content for access by the user.

40. The method of claim 39, comprising:
providing the user with a communication link to upload personal data files to data store; and
loading the personal data files into new phone before delivery to the user.

41. The method of claim 39, comprising:
providing a selection of content for pre-loading to at least one data store provided on the WCD for storage of user services;
loading a portion of the content to the data store; and
providing the loaded portion of the content for access by the user.
